(19) United States
(12) Patent Application Publication
(10) Pub. No.: US 2015/0100415 A1
(43) Pub. Date: Apr. 9, 2015

(54) Position Discount Model Of Content Presented To Online System Users

(71) Applicant: Facebook, Inc., Menlo Park, CA (US)

(72) Inventors: Yintao Yu, Fremont, CA (US); Tao Xu, Cupertino, CA (US); Lars Backstrom, Mountain View, CA (US)

(73) Assignee: Facebook, Inc., Menlo Park, CA (US)

(21) Appl. No.: 14/049,429

(22) Filed: Oct. 9, 2013

(51) Int. Cl. G06Q 30/02

(52) U.S. Cl. CPC G06Q 30/0251
USPC 705/14.49

(57) ABSTRACT

An online system applies position discounts to values of various content items based on the positions in a display in which the content items are presented. The value of presenting a content item is based on historical user interactions with the content item or similar content items. A position discount reflects a change between user interacting with a content item presented in a position offset from a reference position and user interaction with the content item if it was presented in the reference position. A position discount may be determined for various content items presented in one or more positions based on user-specific, contextual, and other types of information describing user interaction with content items. Position discounts may be used by the online system to optimize selection and presentation of content items to its users.

### BACKGROUND

This disclosure relates generally to online systems, and in particular to presentation of content to users of an online system.

Online systems, such as social networking systems, allow users to connect to and communicate with other online system users. Users may create profiles on an online system that are tied to their identities and include information about the users, such as the users' interests and demographic information. The users may be individuals or entities such as corporations or charities. The online system also provides “organic” content items to its users describing actions of other online system users. For example, a feed of content items including various organic content items is presented to a user, allowing the user to receive information about other online system users. Examples of organic content include stories describing actions of other users or stories describing content associated with other users.

In addition to presenting organic content describing users, a social networking system may also present advertisements to its users, allowing the social networking system to obtain revenue by charging advertisers for presentation of the advertisements. Presenting advertisements to social networking system users allows an advertiser to gain public attention for products or services or to persuade social networking system users to take an action regarding the advertiser's products, services, opinions, or causes. A conventional social networking system selects advertisements for presentation to one or more users based on bid amounts associated with various advertisements.

Conventional online systems frequently select advertisements for presentation based on bid amounts associated with various advertisements. An online system frequently charges an advertiser for presentation of an advertisement based on the advertisement's bid amount and bid amounts of other advertisements considered for presentation. Advertisements may be presented along with organic content, such as stories describing actions performed by other online system users.

However, the placement and pricing of advertisements in positions within a feed or other context in which other content items may be offset due to the placement of the advertisements does not take into account a user's likelihood of interacting with advertising and non-advertising content due to the position in which the content is ultimately presented. For example, a vertically scrollable newsfeed with seven slots that presents organic content in the six highest slots and an advertisement priced according to a cost-per-impression pricing scheme in the seventh, and lowest, slot may require a user to scroll down in order to view the advertisement. Here, a user interested in the most recent activity presented in the newsfeed is not likely to scroll down and view the advertisement because of the placement of the organic content above the advertising content. However, in many conventional methods, the advertiser in this scenario is charged for an impression of the advertisement because it was included and rendered in the newsfeed, even if the user did not view the advertisement.

### SUMMARY

To improve advertisement selection and content item presentation, an online system applies position discounts to values of content items presented to a user based on the positions within a display in which various content items are presented and other relevant information. The un-discounted value of a content item is calculated by the online system assuming the content item is placed at the top position or at a certain reference point without an offset. For example, a cost per click advertisement's value is based on a bid amount received from an advertiser associated with the advertisement and the predicted click-through rate of this advertisement. In one embodiment, the value of organic content items is based on the predicted user engagement scores from various events, such as click, like, comment, share etc.

A content item's position discount reflects a predicted change in user interaction with the content item based on a position in a display (e.g., a user interface) where the content item is displayed. Hence, a content item's position discount is based on the position in the display where the content item is displayed, which may be determined as a distance between a position where the content item is displayed and a reference point in the display. For example, the reference position is a position in the display in which a content item is presented if presented alone. In various embodiments, one or more machine-learned models calculate position discounts based on information describing user interaction with content items displayed in various positions of a display. Such information may include user-specific information and contextual information. User-specific information includes, for example, a user's historical frequency of interactions with content items presented in various positions of a display, the types of user interactions with content items presented in various portions of the display, and other information that describes a user's viewing and interacting habits with regard to content presented via the online system. Contextual information includes, for example, the time of day that content items are displayed, the type of browser or device used to display the content items, and other information that describes the presentation and display of content to users of the online system

Different models may be used to determine position discounts for different types of content items. For example, users may be more likely to interact with organic content than with advertisements, so different models are used to determine position discounts for organic content and for advertisements. Different models may be used to determine position discounts for content items based on location or method in which the content items are presented. For example, different models are used to determine position discounts for content items presented in a newsfeed, while a different model is used to determine position discounts for content items presented adjacent to the newsfeed, as the newsfeed may include organic content and advertisements, while advertisements and/or recommendation units are presented adjacent to the newsfeed. A recommendation unit suggests one or more actions to a user viewing the recommendation unit to increase the user's interaction with the social networking system.

A calculated position discount may be used in various ways by the online system to optimize pricing, selection and presentation of advertisements. For example, position discounts are applied to bid amounts associated with advertisements, and the bid amounts modified by the position discounts are used to select and price advertisements for presentation to users of the online system. As another example, position discounts are determined for various positions in a display and used along with a ranking of advertisements based on their associated bid amounts to select advertisements, so higher ranked advertisements are presented in positions associated with the lower position discounts (i.e., larger discount factor). Position discounts may also be used to determine a price charged to an advertiser for presenting an advertisement in a particular position in a display that may include advertising and non-advertising content.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining position discounts associated with content items presented to an online system user, in accordance with an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

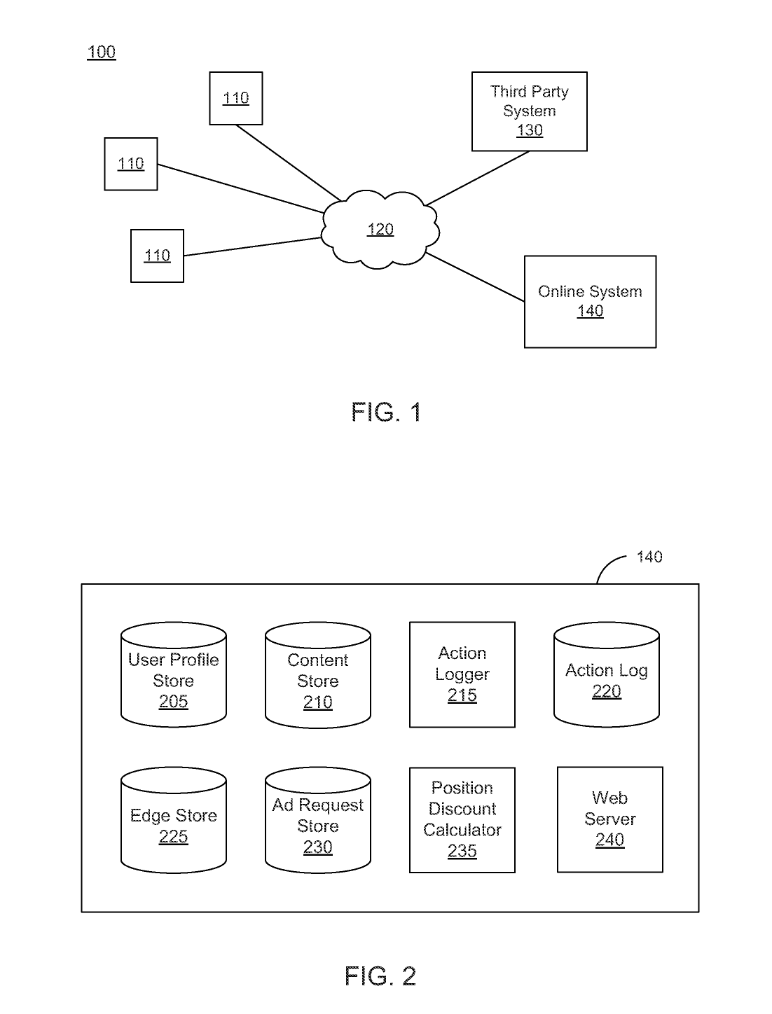

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. For example, the online system 140 is a social networking system. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140, which may be a social networking system in some embodiments. The online system 140 shown in FIG. 2 includes a user profile store 205, a content store 210, an action logger 215, an action log 220, an edge store 225, an ad request store 230, a position discount calculator 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are stored in the ad request store 230. An advertisement request includes advertisement content and a bid amount. The advertisement content is text data, image data, audio data, video data, or any other data suitable for presentation to a user. In various embodiments, the advertisement content also includes a network address specifying a landing page to which a user is directed when the advertisement is accessed.

The bid amount is associated with an advertisement by an advertiser and specifies an amount of compensation the advertiser provides the online system 140 if the advertisement is presented to a user or accessed by a user. In one embodiment, the bid amount is used by the online system to determine an expected value, such as monetary compensation, received by the online system 140 for presenting the advertisement to a user, if the advertisement receives a user interaction, or based on any other suitable condition. For example, the bid amount specifies a monetary amount that the online system 140 receives from the advertiser if the advertisement is displayed and the expected value is determined based on the bid amount and a probability of a user accessing the displayed advertisement.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. The targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The position discount calculator 235 determines a position discount for presenting a content item to an online system user in a position of a display. One or more machine-learned models are used to determine the value of presenting a content item in a position relative to a reference position based on user-specific information and/or contextual information. Examples of user-specific information include the user's historical frequency of interactions with content items presented in various positions of a display and types of interactions by the user with content items presented in various portions of the display. Additionally, examples of contextual information include a time of day when content items are displayed, a type of browser or client device used to display the content items, etc. For example, a machine-learned model is trained to determine position discounts based on a user's historical click-through-rate for content items presented in various positions that include different types of information. In some embodiments, the position discount calculator 235 determines position discounts after the online system 140 receives a request for content from a client device 110. One or more machine-learned models are trained and updated on a regular basis, and at the request runtime the position discount calculator 235 is able to determine position discounts quickly so that a latency associated with the determination is not noticeable to a user of the client device 110.

In one embodiment, the position discount calculator 235 determines whether a user has interacted with and/or has viewed content items based on information received from a tracking mechanism (e.g., a tracking pixel) associated with one or more content items presented by the online system 140. A tracking mechanism may be loaded when one or more rules (e.g., impression rules) indicating that an interaction with a content item or an impression of a content item has occurred are satisfied (e.g., when the content item is displayed in a specified region of a display area). The rules indicating that an interaction or an impression of the content item has occurred may be specified by the online system 140 or by another entity associated with the content item. For example, a tracking pixel is loaded when a user views a content item included in a newsfeed, which identifies an impression with the content item to the action logger 215.

The position discount calculator 235 may use different machine-learned models to determine position discounts for presenting different types of content items. For example, different models are used to determine position discounts for organic content and for advertisements. For example, these different models may account for a higher likelihood of users interacting with organic content than interacting with advertisements. Different machine-learned models may also be used based on the method in which content items are displayed (e.g., horizontally scrolling, vertically scrolling, wrap-around, etc.). For example, a specific model determines position discounts for content items displayed in a vertically scrolling advertisement unit, which associates multiple content items with a single position of the display area and allows a user to vertically navigate through the content items to present different content items in the position, while a different model determines position discounts for content items displayed in a horizontally scrolling advertisement unit, which associates multiple content items with a single position of the display area and allows a user to horizontally navigate through the content items to present different content items in the position. These different models may be used when the online system 140 determines, based on prior user interactions, that users interact differently with horizontally scrolling and vertically scrolling advertisement units. As an additional example, different models are used to determine position discounts for advertisements presented in an advertisement unit associating multiple content items with a single position of the display area and allows a user to navigate through the content items to present different content items in the position by wrapping around from a last advertisement to a first advertisement and for advertisements presented in an advertisement unit associating multiple content items with a single position of the display area and allows a user to navigate through the content items to present different content items in the position by providing multiple inputs to return from a last advertisement to a first advertisement.

The web server 240 links the online system 140 via the network 120 to the one or more client devices 110, as well as to the one or more third party systems 130. The web server 240 serves web pages, as well as other web-related content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that is stored in the content store 210. Additionally, the web server 240 may provide application programming interface (API) functionality to send data directly to native client device operating systems, such as IOS®, ANDROID™, WEBOS®, or BlackberryOS.

### Determining Position Discounts

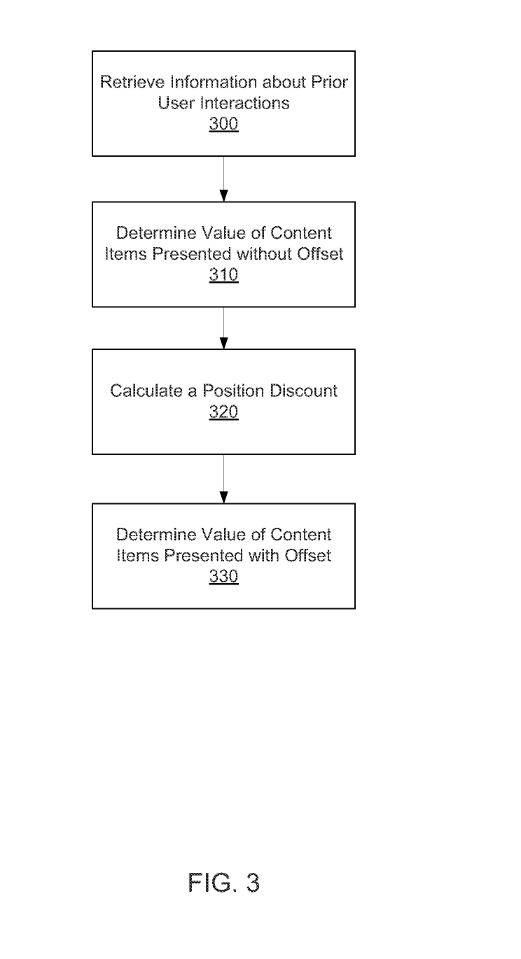

FIG. 3 is a flowchart of one embodiment of a method for determining position discounts associated with content items presented to an online system user. The online system 140 retrieves 300 information describing interactions of online system users with content items previously presented to the users by the online system 140. Examples of user interactions with content items include indicating a preference for a content item (i.e., “liking” the content item), posting a comment associated with a content item, sending a content item to an additional user, viewing a content item, or other suitable interactions. The retrieved information may be organized based on one or more criteria. Examples of criteria for organizing retrieved user interactions include characteristics of users interacting with content items (e.g., age, gender, location, etc.), a position in which previously presented content items were displayed relative to a reference position of a display, a time of day when content items were presented, a geographic location where content items were previously presented, a type of previously presented content item (e.g., advertisement, organic content item, sponsored story, status update, etc.), information included in a previously presented content item (e.g., images, audio, video, text), a type of application in which content items were presented, and a type of device on which content items were previously presented.

Based on the retrieved information about user interactions with previously-presented content items and other relevant information, values for presenting content items to online system users in a reference position of a display (i.e., without an offset) are determined 310. For example, the value of presenting a cost per click advertisement in the reference position is determined 310 based on its bid amount and the estimated click-through rate. And the estimated click-through rate is determined based on the retrieved information about user interactions with previously-presented content items and other relevant information. As an additional example, the value of organic content items is determined 310 based on a number of times or a frequency with which a user views or interacts with organic content items previously presented in the reference position. As described above in conjunction with FIG. 2, user interaction with a content item (e.g., a click-through-rate, a number of comments, a number of indications of preference, a number of times, etc.) or impressions of a content item may be tracked by a tracking mechanism loaded by the online system 140 when rules (e.g., impression rules) indicating an interaction or impression of a content item are satisfied.

Position discount for presenting the content item in a position offset from the reference position is calculated 320. In one embodiment, one or more machine learned models are trained based on the change in user interactions between presenting the content item without an offset from the reference position and presenting the content item with an offset from the reference position to calculate 320 a position discount for advertisements and organic content items in various positions. In one embodiment, a larger position discount (i.e., a smaller discount factor) is calculated 320 for positions corresponding to greater changes in user interactions of content items than when the content items are presented in the reference position while a smaller position discount (i.e., a larger discount factor) is calculated 320 for positions corresponding to smaller changes in user interactions of content items than when the content items are presented in the reference position. For example, if the online system 140 determines that presenting organic content items in the second slot of a newsfeed has a small change in value relative to presenting organic content items in a first slot of the newsfeed for a certain user in a certain context, a machine-learned model calculates a position discount of 5%, which corresponds to a discount factor of 0.95, for presenting an organic content item for this specific user in the given context in the second slot. As an additional example, if the online system 140 determines that an advertisement presented in a position having a 1,000 pixel offset from a reference position for a certain user at 4 A.M. has a position discount of 70% from presentation of the advertisement in the reference position, a discount factor of 0.30, is applied to determine the value of this advertisement with offset considered.

In one embodiment, based on the determined value of a content item in the reference position without offset and the calculated position discount, value of presenting a content item with offset is determined 330. As an example, a cost per click advertisement has $1 bid on click and 2% estimated click-through rate in the reference position without offset, so the value of the advertisement may be determined 310 as $20 estimated CPM (cost per mille) without offset. If the advertisement's position discount is calculated 320 as 20% for a given user at a certain offset and context, or a discount factor of 0.8, the value of this advertisement with offset for this specific user at this offset and context is determined 330 as $16 estimated CPM with 1.6% final estimated click-through rate. In another embodiment, the value of presenting a content item with offset may be determined 330 without separately calculating 320 a position discount. In that embodiment, the position discount calculator 235 determines 330 the value of a content item presented with offset based on the determined value of content item without offset as well as position information, offset information, and other relevant user and contextual information. Different machine-learned models may be used for different users, different types of content items (e.g., advertising and organic content items), different types of formats for presenting content items (e.g., vertically scrolling advertisement units, automatically scrolling advertisement units, etc.), different positions within a display (e.g., along the side of a display, in a banner, etc.), or based on any other suitable factors. In some embodiments, characteristics in addition to a display position's offset from a reference position may be used to determine a position discount. Examples of additional characteristics for determining a position discount include user-specific characteristics, contextual characteristics and their combinations. Examples of user-specific characteristics include age range, gender, location, a user's historical frequency of interactions with content items presented in various positions of a display, users' historical frequency of interactions with content items presented in various positions of a display based on users in the same age range, the types of user interactions with content items presented in various portions of the display, and other information describing a user's or a specific set of users' viewing and interacting habits with regard to content presented via the online system 140. Contextual characteristics include, for example, the time of day that content items are displayed, the geographic location where content items are presented, the type of browser or device used to display the content items, and other information describing presentation and display of content to users of the online system 140. Combinations of user-specific and contextual characteristics include, for example, users' historical frequency of interactions with content items presented in various positions of a display based on users in the same age range at the same time of the day that content items are displayed.

### Application of Position Discounts

A calculated position discount may be used by the online system 140 when selecting content items for presentation to online system users. For example, position discounts are applied to bid amounts associated with advertisements. And one or more advertisements are selected for presentation based on their bid amounts after application of position discounts. As another example, position discounts for presenting content items in various positions of a newsfeed are determined and an order in which content items are presented in positions of the newsfeed is determined to maximize the overall value of the presented content items with position discounts applied.

Position discounts may be applied to different positions in which content items may be presented so that advertisements associated with higher bid amounts are presented in positions associated with lower position discounts. For example, to determine the layout of an advertisement unit having five slots, position discounts are determined for each slot in the advertisement unit. The advertisements with the five highest bid amounts are mapped to each of the five slots so that advertisements associated with higher bid amounts are presented in slots having lower position discounts (i.e., larger discount factor). Conversely, advertisements associated with lower bid amounts among the five advertisements are presented in slots having higher position discounts (i.e., smaller discount factor).

The online system 140 may also determine the price charged to an advertiser for presenting an advertisement based on a position discount associated with a position in which the advertisement was presented. For example, after determining the positions of content items in a newsfeed, position discounts for positions in the display in which advertisements are presented are applied to advertisements' estimated value before the auction and pricing. This allows the price charged to advertisers to reflect decreases in likely user engagement with advertisements based on the position in which the advertisements were presented.

### Example Machine Learning Model

For purposes of illustration, an example of a machine learning module for training and determining position discount is described. In this example, an input, x, which is a vector of feature values is provided to a model, h_{θ}, where parameters of θ are to be learned from training data. Application of the module to the input, or h_{θ}(x), results in a position discount value, which is in the range of [0,1]. As an example, application of the model to the input allows determination of a final estimated click-through rate (eCTR) with offset considered, according to:

Final eCTR=TPeCTR*h_{θ}(x) (1)

where TPeCTR is a top position eCTR (i.e., the eCTR value without any discounting, given the display of the advertisement at the reference position without any offset, such as the topmost position in a user's newsfeed or a topmost position in a column presented adjacent to the user's newsfeed). While the preceding example describes determination of click event, in other embodiments, other events (e.g., conversion events, like, comment, share, etc.) may be similarly determined. Also, if the position discount is allowed to be larger than 1, the position discount may be cap*h_{θ}(x), where cap is the maximum allowed position discount. In this example, it is assumed cap is 1.

In some embodiments, a cost function for each presentation of an advertisement (impression) may be calculated by:

$$Cost ( {h}_{θ} ( x ) , TPeCTR , y ) = \{ \begin{matrix}- log ( TPeCTR * {h}_{θ} ( x ) ) if y = 1 \\ - log ( 1 - TPeCTR * {h}_{θ} ( x ) ) if y = 0\end{matrix} \qquad ( 2 )$$

where y=1 indicates a user clicked an advertisement or a story, and y=0 indicates a user did not click the advertisement or the story. In an implementation where y is either 1 or 0, Cost(h_{θ}(x), TPeCTR, y) may be rewritten as:

Cost(h_{θ}(x),TPeCTR,y)=−y*log(TPeCTR*h_{θ}(x))−(1−y)*log(1−TPeCTR*h_{θ}(x)) (3)

Thus, the overall cost function is:

$$\begin{matrix}J ( θ ) = \frac{1}{m} {\sum }_{i = 1}^{m} Cost ( {h}_{θ} ( {x}^{( i )} ) , TPeCTR , {y}^{( i )} ) \\ = - \frac{1}{m} {\sum }_{i = 1}^{m} {y}^{( i )} * log ( {TPeCTR}^{( i )} * {h}_{θ} ( {x}^{( i )} ) ) + ( 1 - {y}^{( i )} ) * ( 5 ) \\ log ( 1 - {TPeCTR}^{( i )} * {h}_{θ} ( {x}^{( i )} ) )\end{matrix} \qquad ( 4 )$$

To minimize the overall cost function, by finding θ that can achieve min_{θ} J(θ), and assuming that h_{θ}(x) is a logistic function, i.e.,

$${h}_{θ} ( x ) = \frac{1}{1 + {e}^{- θ {T}_{x}}} ,$$

a close-form formula can be used to update θ via gradient descent in an iterative manner. For example:

$${θ}_{j}^{〈 next\_iter 〉} := {θ}_{j} - α \frac{\partial }{\partial {θ}_{j}} J ( θ ) \qquad ( 6 )$$

where α is the learning rate, and

$$\frac{\partial }{\partial {θ}_{j}} J ( θ ) = - \frac{1}{m} {\sum }_{i = 1}^{m} ( \frac{{e}^{- θ {T}_{x} ( i )}}{1 + {e}^{- θ {T}_{x} ( i )}} ( {y}^{( i )} + ( {y}^{( i )} - 1 ) \frac{{TPeCTR}^{( i )}}{1 + {e}^{- θ {T}_{x} ( i )} - {TPeCTR}^{( i )}} ) {x}_{j}^{( i )} ) \qquad ( 7 )$$

Additionally, in embodiments where TPeCTR is 1 for all i, the above formula may be simplified as:

$$\begin{matrix}\frac{\partial }{\partial {θ}_{j}} J ( θ ) = - \frac{1}{m} {\sum }_{i = 1}^{m} ( \frac{{e}^{- θ {T}_{x} ( i )}}{1 + {e}^{- θ {T}_{x} ( i )}} {y}^{( i )} {x}_{j}^{( i )} + \frac{1}{1 + {e}^{- θ {T}_{x} ( i )}} ( {y}^{( i )} - 1 ) {x}_{j}^{( i )} ) & ( 8 ) \\ \frac{\partial }{\partial {θ}_{j}} J ( θ ) = - \frac{1}{m} {\sum }_{i = 1}^{m} ( {y}^{( i )} {x}_{j}^{( i )} ( \frac{{e}^{- θ {T}_{x} ( i )}}{1 + {e}^{- θ {T}_{x} ( i )}} + \frac{1}{1 + {e}^{- θ {T}_{x} ( i )}} ) - \frac{1}{1 + {e}^{- θ {T}_{x} ( i )}} {x}_{j}^{( i )} ) & ( 9 ) \\ \frac{\partial }{\partial {θ}_{j}} J ( θ ) = - \frac{1}{m} {\sum }_{i = 1}^{m} ( {y}^{( i )} {x}_{j}^{( i )} - \frac{1}{1 + {e}^{- θ {T}_{x} ( i )}} {x}_{j}^{( i )} ) & ( 10 ) \\ \frac{\partial }{\partial {θ}_{j}} J ( θ ) = - \frac{1}{m} {\sum }_{i = 1}^{m} ( {y}^{( i )} - {h}_{θ} ( {x}^{( i )} ) ) {x}_{j}^{( i )} & ( 11 )\end{matrix}$$

This simplified formula is the same as a regular logistic regression gradient descent update formula. Hence, the preceding example is a more general approach that may also solve regular logistic regression.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the embodiments, which is set forth in the following claims.

What is claimed is:

1. A method comprising:
determining a value describing user interaction with a content item presented in a reference position of a user interface for an online system;
computing a discount associated with presenting the content item to a user of the online system in a specified position of the user interface, the discount providing a measure of a change in likelihood of user interaction with the content item when the content item is presented in the specified position; and
determining a value describing an expected amount of user interaction with presenting the content item when the content item is presented in the specified position based at least in part on the computed discount and the determined value of user interaction with the content item presented in the reference position.

2. The method of claim 1, wherein the specified position of the user interface is located a determined distance from the reference position.

3. The method of claim 2, wherein the determined distance from the reference position comprises a number of pixels between the reference position and the specified position.

4. The method of claim 1, wherein the user interface comprises a feed including a plurality of slots for presenting content items, and the specified position comprises a slot located a number of slots from a slot corresponding to the reference position.

5. The method of claim 1, wherein the content item comprises an advertisement.

6. The method of claim 1, further comprising:
retrieving information about one or more interactions between one or more users of the online system and the content item maintained by the online system;
wherein the one or more interactions between one or more users of the online system with the content item maintained by the online system are selected from a group consisting of: accessing the content item, indicating a preference for the content item, commenting on the content item, sharing the content item with an additional user of the online system, installing an application associated with the content item, accessing an application associated with the content item, purchasing a product associated with the content item, purchasing a service associated with the content item, viewing data associated with the content item, requesting a subscription associated with the content item, and any combination thereof.

7. The method of claim 1, wherein the discount associated with presenting the content item in the specified position is further based on one or more selected from a group consisting of: a location of a display including the user interface on which the content item is to be presented, one or more characteristics of the user, a time of day during which the content item is to be presented, a subject of the content item, one or more components of the content item, one or more characteristics of a client device on which the content item is to be presented, and any combination thereof.

8. The method of claim 7, wherein the subject of the content item is selected from a group consisting of: advertisement content and organic content.

9. The method of claim 1, wherein a content item comprising an advertisement content item is associated with an estimated value, which is based at least in part on a bid amount associated with the advertisement.

10. The method of claim 9, further comprising:
determining the estimated value of the advertisement based at least in part on the determined discount.

11. The method of claim 1, further comprising:
determining a price charged to an advertiser for presentation of the advertisement to the user based at least in part on the determined discount.

12. A system comprising:
a processor;
a computer readable storage medium coupled to the processor, the computer readable storage medium including instructions that, when executed by the processor, cause the processor to:
determine a value describing user interaction with a content item presented in a reference position of a user interface for an online system;
compute a discount associated with presenting the content item to a user of the online system in a specified position of the user interface, the discount providing a measure of a change in likelihood of user interaction with the content item when the content item is presented in the specified position; and
determine a value describing an expected amount of user interaction with presenting the content item when the content item is presented in the specified position based at least in part on the computed discount and the determined value of user interaction with the content item presented in the reference position.

13. The system of claim 12, wherein the specified position of the user interface is located a determined distance from the reference position.

14. The system of claim 13, wherein the determined distance from the reference position comprises a number of pixels between the reference position and the specified position.

15. The system of claim 12, wherein the user interface comprises a feed including a plurality of slots for presenting content items, and the specified position comprises a slot located a number of slots from a slot corresponding to the reference position.

16. The system of claim 12, wherein the content item comprises an advertisement.

17. The system of claim 12, wherein the instructions, when executed by the processor, further cause the processor to:
retrieve information about one or more interactions between one or more users of the online system and the content item maintained by the online system;
wherein the one or more interactions between one or more users of the online system with the content item maintained by the online system are selected from a group consisting of: accessing the content item, indicating a preference for the content item, commenting on the content item, sharing the content item with an additional user of the online system, installing an application associated with the content item, accessing an application associated with the content item, purchasing a product associated with the content item, purchasing a service associated with the content item, viewing data associated with the content item, requesting a subscription associated with the content item, and any combination thereof.

18. The system of claim 12, wherein the discount associated with presenting the content item in the specified position is further based on one or more selected from a group consisting of: a location of a display including the user interface on which the content item is to be presented, one or more characteristics of the user, a time of day during which the content item is to be presented, a subject of the content item, one or more components of the content item, one or more characteristics of a client device on which the content item is to be presented, and any combination thereof.

19. The system of claim 18, wherein the subject of the content item is selected from a group consisting of: advertisement content and organic content.

20. The system of claim 12, wherein a content item comprising an advertisement content item is associated with an estimated value, which is based at least in part on a bid amount associated with the advertisement.
